(19) United States
(12) Patent Application Publication
(10) Pub. No.: US 2016/0029842 A1
(43) Pub. Date: Feb. 4, 2016

(54) Grease Containing Assembly

(71) Applicant: Kathy Taylor, Spring Creek, NV (US)

(72) Inventor: Kathy Taylor, Spring Creek, NV (US)

(21) Appl. No.: 14/449,532

(22) Filed: Aug. 1, 2014

(51) Int. Cl. A47J 37/07; B65D 25/38; B65D 43/02; B65D 25/10; B65D 25/28

(52) U.S. Cl. CPC A47J 37/0786; B65D 25/10; B65D 25/2805; B65D 43/02; B65D 25/38

(57) ABSTRACT

A grease containing assembly contains grease splatter and prevents spills when cooking with greasy foods. The assembly includes a container having a bottom wall and a perimeter wall coupled to and extending upwardly from the bottom wall. A lid is removably couplable to the container for securing the lid to the container. A pair of handles is coupled to the container. The handles are positioned on opposite ends of the perimeter wall. A pair of connectors is coupled to and extends from the lid. Each of the connectors is engageable with an associated one of the handles to secure the lid to the container. A tray is positionable in the interior space of the container. The tray has a plurality of openings positioned therein configured for draining grease from food items positioned on the tray.

### BACKGROUND OF THE DISCLOSURE

1. Field of the Disclosure

The disclosure relates to grease containment devices and more particularly pertains to a new grease containment device for containing grease splatter and preventing spills when cooking with greasy foods.

2. Summary of the Disclosure

An embodiment of the disclosure meets the needs presented above by generally comprising a container having a bottom wall and a perimeter wall coupled to and extending upwardly from the bottom wall. A lid is removably couplable to the container for securing the lid to the container. A pair of handles is coupled to the container. The handles are positioned on opposite ends of the perimeter wall. A pair of connectors is coupled to and extends from the lid. Each of the connectors is engageable with an associated one of the handles to secure the lid to the container. A tray is positionable in the interior space of the container. The tray has a plurality of openings positioned therein configured for draining grease from food items positioned on the tray.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a grease containing assembly according to an embodiment of the disclosure.

FIG. 2 is a bottom view of an embodiment of the disclosure.

FIG. 3 is a front view of an embodiment of the disclosure.

FIG. 4 is a side view of an embodiment of the disclosure.

FIG. 5 is a top front side perspective view of an embodiment of the disclosure showing both of the trays being removed from the container.

### DESCRIPTION OF THE PREFERRED EMBODIMENT

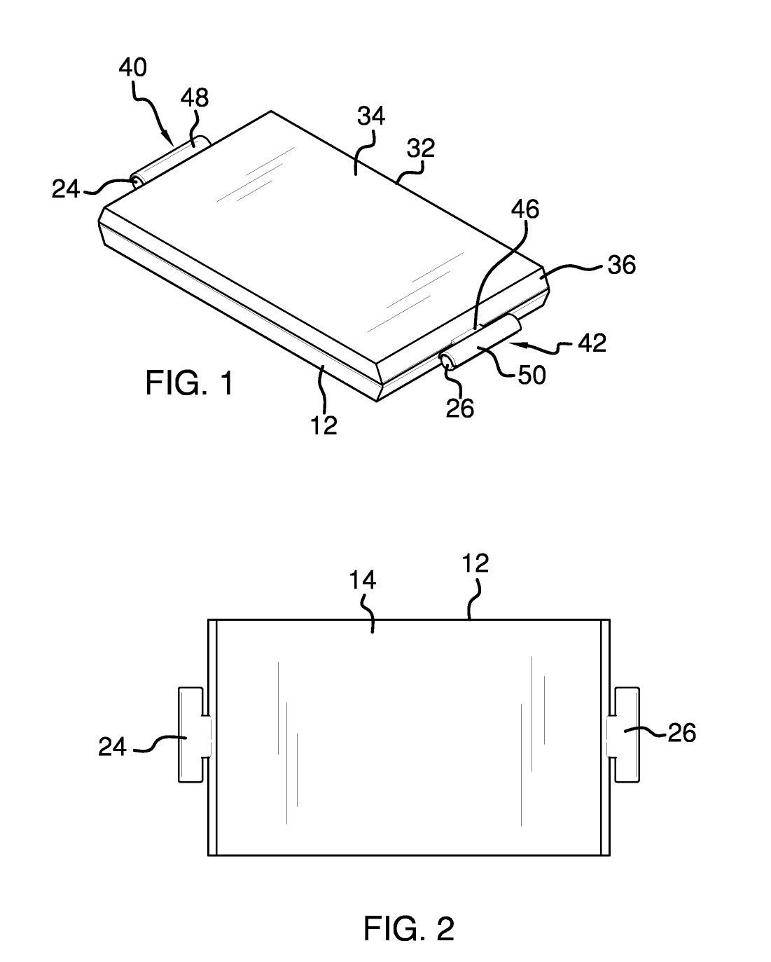

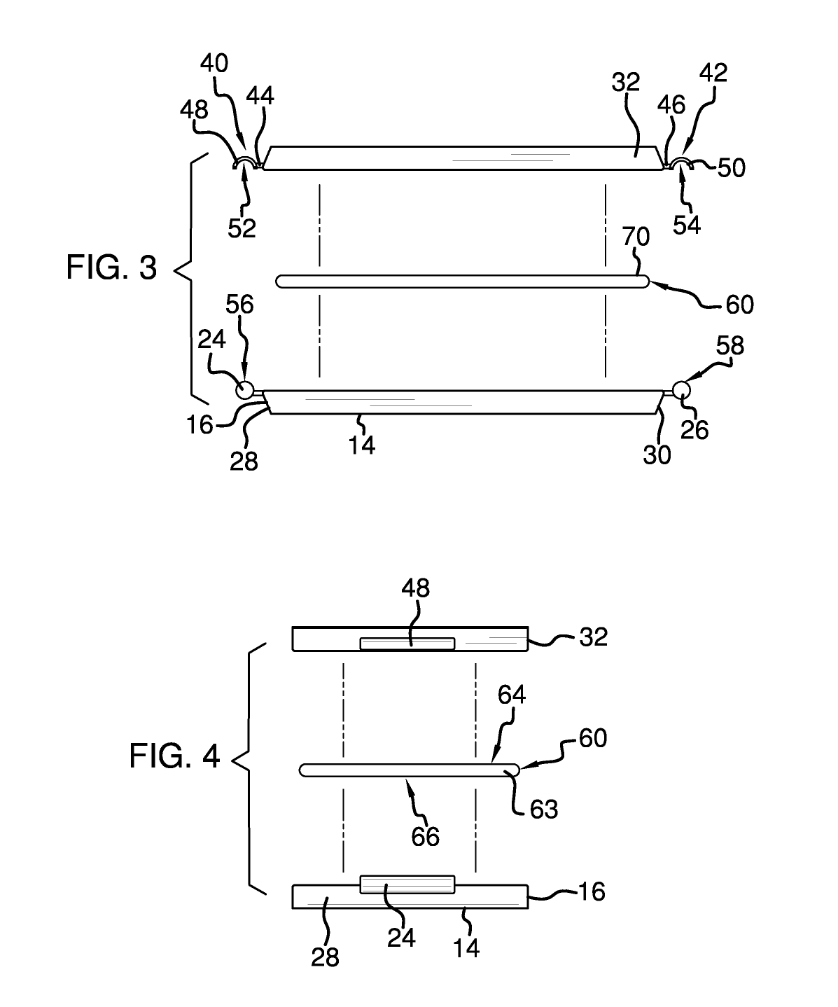

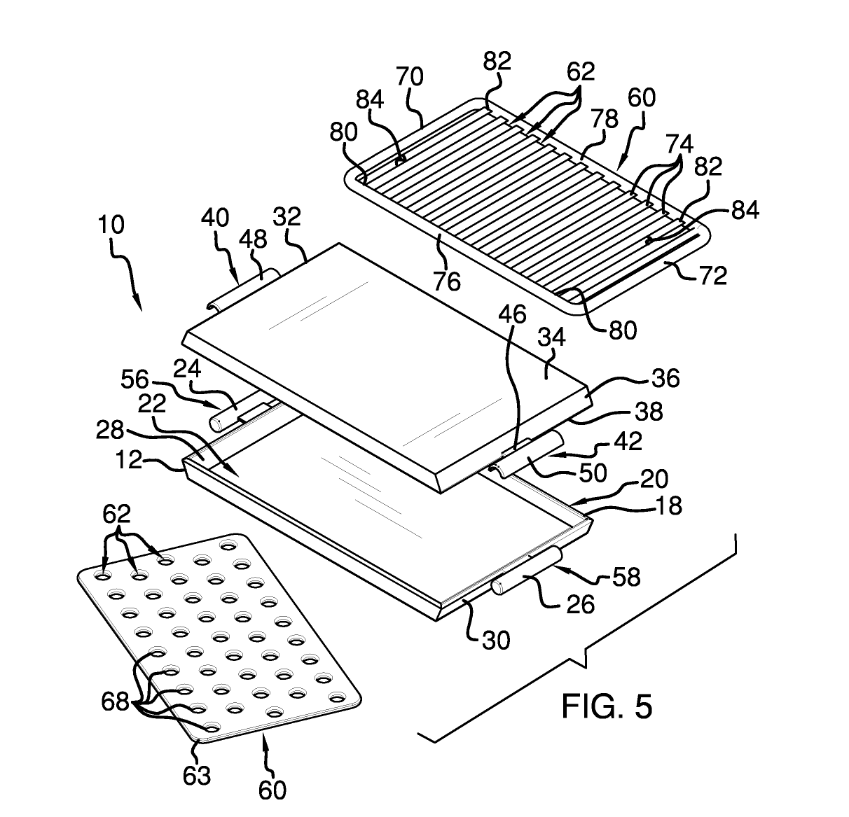

With reference now to the drawings, and in particular to FIGS. 1 through 5 thereof, a new grease containment device embodying the principles and concepts of an embodiment of the disclosure and generally designated by the reference numeral 10 will be described.

As best illustrated in FIGS. 1 through 5, the grease containing assembly 10 generally comprises a container 12 having a bottom wall 14 and a perimeter wall 16 coupled to and extending upwardly from the bottom wall 14. A top edge 18 of the perimeter wall 16 defines an access opening 20 into an interior space 22 of the container 12. The perimeter wall 16 may taper outwardly from the bottom wall 14 to the top edge 18 of the perimeter wall 16. A pair of handles 24, 26 is coupled to the container 12. The handles 24, 26 are positioned on opposite ends 28, 30 of the perimeter wall 16. More particularly, each of the handles 24, 26 is elongated and tubular.

A lid 32 is positionable on the top edge 18 of the perimeter wall 16 for closing the access opening 20. The lid 32 is removably couplable to the container 12 for securing the lid 32 to the container 12. The lid 32 includes an upper wall 34 and a peripheral wall 36 coupled to and extending downwardly from the upper wall 34. A bottom edge 38 of the peripheral wall 36 abuts the top edge 18 of the perimeter wall 16 of the container 12 when the lid 32 is coupled to the container 12. The peripheral wall 36 of the lid 32 may taper outwardly from the upper wall 34 to the bottom edge 38 of the peripheral wall 36.

A pair of connectors 40, 42 each is coupled to and extends from the lid 32. The connectors 40, 42 are alignable with the handles 24, 26 wherein each of the connectors 40, 42 is engageable with an associated one of the handles 24, 26 to secure the lid 32 to the container 12. Each of the connectors 40, 42 comprises an arm section 44, 46 and a connecting section 48, 50. The arm section 44, 46 couples the connecting section 48, 50 to the lid 32. The connecting section 48, 50 is concavely arcuate wherein the connecting section 48, 50 of each connector 40, 42 is complementary to a shape of the handles 24, 26 such that an inner surface 52, 54 of the connecting section 48, 50 abuts at least a portion of an outer surface 56, 58 of the associated handle 24, 26 when the connecting section 48, 50 engages the associated handle 24, 26.

A plurality of trays 60 is provided. A selectable one of the trays 60 is positionable in the interior space 22 of the container 12. Each tray 60 has a plurality of openings 62 positioned therein configured for draining grease from food items positioned on the associated tray 60. The plurality of trays 60 includes a drain panel 63. The drain panel 63 has an upper surface 64 and a lower surface 66 each being planar. The openings 62 in the drain panel 63 may be circular holes 68 each spaced from adjacently positioned holes 68.

The plurality of trays 60 also includes a drain rack 70 having a perimeter lip 72. The drain rack 70 includes a plurality of slats 74 coupled to and extending between opposite sides 76, 78 of the perimeter lip 72. Each of the slats 74 has a longitudinal axis extending between a first end 80 and a second end 82 of the associated slat 74. The slats 74 are spaced and aligned relative to each other along the longitudinal axes of the slats 74 forming the openings 62 between each of the slats 74 and between the opposite sides 76, 78 of the perimeter lip 72. Each of the slats 74 has a top surface 84 horizontally orientated relative to the perimeter lip 72 of the drain rack 70 wherein the top surface 84 of each slat 74 is configured to support the food item placed thereon.

In use, a selectable tray 60 is positioned in the interior space 22 of the container 12. Greasy food, such as bacon, sausage, steak or the like, is positioned on the selected tray 60. The food is then cooked in an oven in a conventional manner. The openings 62 in the tray 60 allow grease from the food to drain therethrough during cooking. The lid 32 secures to the container 12 using the connectors 40, 42 to prevent grease from splattering and/or spilling out of the container 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A grease containing assembly comprising:
a container having a bottom wall and a perimeter wall coupled to and extending upwardly from said bottom wall, a top edge of said perimeter wall defining an access opening into an interior space of said container;
a lid positionable on said top edge of said perimeter wall for closing said access opening, said lid being removably couplable to said container for securing said lid to said container;
a pair of handles coupled to said container, said handles being positioned on opposite ends of said perimeter wall;
a pair of connectors each being coupled to and extending from said lid, said connectors being alignable with said handles, each of said connectors being engageable with an associated one of said handles to secure said lid to said container; and
a tray being positionable in said interior space of said container, said tray having a plurality of openings positioned therein configured for draining grease from food items positioned on said tray.

2. The assembly of claim 1, further comprising wherein said tray comprises a drain panel, said drain panel having an upper surface and a lower surface each being planar, said openings in said drain panel being holes extending through each of said upper and lower surfaces, each said hole being spaced from adjacently positioned said holes.

3. The assembly of claim 1, further comprising wherein said tray comprises a drain rack having a perimeter lip, said drain rack including a plurality of slats coupled to and extending between opposite sides of said perimeter lip, each of said slats having a longitudinal axis extending between a first end and a second end of said associated slat, said slats being spaced and aligned relative to each other along said longitudinal axes of said slats and forming said openings between each of said slats and between said opposite sides of said perimeter lip.

4. The assembly of claim 3, further comprising each of said slats having a top surface being horizontally orientated relative to said perimeter lip of said drain rack wherein said top surface of each said slat is configured to support the food item placed thereon.

5. The assembly of claim 1, further comprising said perimeter wall tapering outwardly from said bottom wall to said top edge of said perimeter wall.

6. The assembly of claim 1, further comprising said lid including an upper wall and a peripheral wall coupled to and extending downwardly from said upper wall, a bottom edge of said peripheral wall abutting said top edge of said perimeter wall of said container when said lid is coupled to said container.

7. The assembly of claim 6, further comprising said peripheral wall of said lid tapering outwardly from said upper wall to said bottom edge of said peripheral wall.

8. The assembly of claim 1, further comprising each of said handles being elongated and tubular.

9. The assembly of claim 8, further comprising each of said connectors comprising an arm section and a connecting section, said arm section coupling said connecting section to said lid, said connecting section being concavely arcuate wherein said connecting section of each said connector is complementary to a shape of said handles such that an inner surface of said connecting section abuts at least a portion of an outer surface of said associated handle when said connecting section engages said associated handle.

10. A grease containing assembly comprising:
a container having a bottom wall and a perimeter wall coupled to and extending upwardly from said bottom wall, a top edge of said perimeter wall defining an access opening into an interior space of said container, said perimeter wall tapering outwardly from said bottom wall to said top edge of said perimeter wall;
a lid positionable on said top edge of said perimeter wall for closing said access opening, said lid being removably couplable to said container for securing said lid to said container, said lid including an upper wall and a peripheral wall coupled to and extending downwardly from said upper wall, a bottom edge of said peripheral wall abutting said top edge of said perimeter wall of said container when said lid is coupled to said container, said peripheral wall of said lid tapering outwardly from said upper wall to said bottom edge of said peripheral wall;
a pair of handles coupled to said container, said handles being positioned on opposite ends of said perimeter wall, each of said handles being elongated and tubular;
a pair of connectors each being coupled to and extending from said lid, said connectors being alignable with said handles, each of said connectors being engageable with an associated one of said handles to secure said lid to said container, each of said connectors comprising an arm section and a connecting section, said arm section coupling said connecting section to said lid, said connecting section being concavely arcuate wherein said connecting section of each said connector is complementary to a shape of said handles such that an inner surface of said connecting section abuts at least a portion of an outer surface of said associated handle when said connecting section engages said associated handle; and
a plurality of trays, a selectable one of said trays being positionable in said interior space of said container, each said tray having a plurality of openings positioned therein configured for draining grease from food items positioned on said associated tray, said plurality of trays including;
a drain panel, said drain panel having an upper surface and a lower surface each being planar, said openings in said drain panel being holes extending through each of said upper and lower surfaces, each said hole being spaced from adjacently positioned said holes; and
a drain rack having a perimeter lip, said drain rack including a plurality of slats coupled to and extending between opposite sides of said perimeter lip, each of said slats having a longitudinal axis extending between a first end and a second end of said associated slat, said slats being spaced and aligned relative to each other along said longitudinal axes of said slats and forming said openings between each of said slats and between said opposite sides of said perimeter lip, each of said slats having a top surface being horizontally orientated relative to said perimeter lip of said drain rack wherein said top surface of each said slat is configured to support the food item placed thereon.
